(19) United States
(12) Patent Application Publication
(10) Pub. No.: US 2026/0317585 A1
(43) Pub. Date: Oct. 15, 2026

(54) USE OF POLYURETHANE DISPERSIONS FOR PRODUCTION OF LATENTLY REACTIVE ADHESIVE LAYERS AND SELF-SUPPORTING ADHESIVE FILMS

(71) Applicant: Covestro Deutschland AG, Leverkusen (DE)

(72) Inventors: Christoph Thiebes, Köln (DE); Thomas Fait, Köln (DE); wolfgang Amdt, Dormagen (DE); Jan Weikard, Leverkusen (DE); Zhirong Fan, Langenfeld (DE)

(21) Appl. No.: 19/485,330

(22) PCT Filed: May 17, 2024
(86) PCT No.: PCT/EP2024/063778

§ 371 Date: Nov. 18, 2025

(30) Foreign Application Priority Data
May 25, 2023 (EP) 23175389.8
Aug. 10, 2023 (EP) 23190785.8

(51) Int. Cl. C09J 5/06; C08G 18/08; C08G 18/42; C08G 18/79; C08G 18/83; C09J 175/04

(52) U.S. Cl. CPC C09J 5/06; C08G 18/833; C09J 175/04; C08G 18/0823; C08G 18/0828; C08G 18/42; C08G 18/797; C09J 2301/408; C09J 2475/00

(57) ABSTRACT

The present invention relates to the use of an aqueous dispersion for production of storage-stable and latently reactive adhesives, wherein the aqueous dispersion contains at least the following dispersed components: (A) at least one semicrystalline or crystalline polyurethane polymer containing carboxyl groups which has a melting temperature in the range of 35 to 80° C., an enthalpy of fusion of ≥15 J/g and a partial acid number in the range from 0.8 mg KOH/g to 25 mg KOH/g; (B) at least one polycarbodiimide, at least one polyaziridine and/or a mixture thereof, where the at least one polycarbodiimide and the at least one polyaziridine have a glass transition temperature in the range from −150° C. to 30° C.; (C) optionally at least one further polymer other than the at least one polymer (A); and (D) optionally at least one additive other than components (A), (B) and (C). In addition, a method of bonding at least two substrates or at least two surface regions of a substrate and an adhesive bond.

The present invention relates to the use of an aqueous dispersion for production of storage-stable and latently reactive adhesives, wherein the aqueous dispersion contains at least the following dispersed components: (A) at least one semicrystalline or crystalline polyurethane polymer containing carboxyl groups which has a melting temperature in the range of 35 to 80° C., an enthalpy of fusion of ≥15 J/g and a partial acid number in the range from 0.8 mg KOH/g to 25 mg KOH/g; (B) at least one polycarbodiimide, at least one polyaziridine and/or a mixture thereof, where the at least one polycarbodiimide and the at least one polyaziridine have a glass transition temperature in the range from −150° C. to 30° C.; (C) optionally at least one further polymer other than the at least one polymer (A); and (D) optionally at least one additive other than components (A), (B) and (C). In addition, a method of bonding at least two substrates or at least two surface regions of a substrate and an adhesive bond.

Adhesives based on aqueous polyurethane dispersions have become established worldwide in demanding industrial uses, for example in shoe manufacture, in the bonding of furniture parts, in the bonding of parts for motor vehicle interiors, in sheet lamination or in the bonding of textile substrates. The production of aqueous polyurethane or polyurethane-polyurea dispersions is known.

When such dispersions are used for bonding of substrates, this is usually done by the thermal activation method. In this method, the dispersion is applied to the substrate and, once the water has completely evaporated, the adhesive layer is activated by heating, for example using an infrared radiator, and is converted into an adhesive state. The temperature at which the adhesive film becomes tacky is referred to as the activation temperature. The adhesives used in these methods in many cases contain crystalline components that are in molten form at or above the activation temperature.

Adhesives based on aqueous polyurethane or polyurethane-polyurea dispersions that are suitable for the use of the thermal activation method are described in U.S. Pat. No. 4,870,129. Accordingly, by use of specific mixtures of diisocyanates and polyol components by the acetone method, it is possible to obtain aqueous polyurethane or polyurethane-urea dispersions. The films obtainable therefrom have good activatability.

However, when using polyurethane dispersions or polyurethane-polyurea dispersions, it is also possible to work by the wet-bonding method, meaning that bonding follows immediately after application of the adhesive. The parts to be joined need to be mechanically fixed in place until the adhesive has set. This method is often used for the bonding of wood or textile substrates.

It is also possible to add polycarbodiimide dispersions to the adhesives based on aqueous polyurethane or polyurethane-urea dispersions. These polycarbodiimide dispersions are used inter alia as crosslinking agents for aqueous adhesives, coating agents or paints. However, a disadvantage of this teaching is that the crosslinking reaction in the adhesive/varnish layer begins as soon as the aqueous coating has dried and then proceeds with great rapidity. This significantly restricts use for production of storage-stable preliminary coatings of substrate surfaces, self-supporting latently reactive adhesive films or reactive adhesive powders.

EP3730528A1 describes latently reactive adhesive compositions based on solid polycarbodiimides having a glass transition temperature of at least 30° C., which can be processed in combination with polymer dispersions containing carboxyl groups to give self-supporting latently reactive adhesive films or reactive adhesive powders. However, the solid polycarbodiimides used must be in the form of a very fine powder in order to achieve sufficient reactivity. This is not only very complex in terms of production but also harbours the further problem that it has a tendency to agglomerate in solid form in the course of storage, and that there can be sedimentation in aqueous adhesive formulations. Moreover, the reactivity of the resultant adhesive films is inadequate. Solid polycarbodiimides in the context of the present invention mean polycarbodiimides having a glass transition temperature of more than +30° C.

In the manufacturing industry, there is however a pressing need for spatial and temporal separation between application of the adhesive and the joining process. If, for example, (partially) crystalline polyurethane dispersion polymers are used for the joining process, it is advantageous when the crosslinking reaction of the adhesive polymer is initiated only by the heating of the adhesive layer that is necessary in any event before or during the joining process. Those skilled in the art of this technical field will consider “dispersion polymers” to mean those polymers that can be used in a fundamentally known manner as a dispersed phase in aqueous dispersions. These dispersion polymers are also referred to as “dispersible polymers”. In a dispersion polymer, the polymer in the polymer particles (disperse phase) is accordingly in a colloidally stable polymer dispersion. In the case of polyurethane dispersions, the continuous phase is usually water. A polymer dispersion thus consists of at least one disperse phase (polymer particles) and one continuous phase (the dispersion medium).

When the polymer dispersion is applied to a substrate and the dispersion medium evaporated, the dispersion polymer gives rise to a polymer film, provided the temperature of the polymer is above the minimum film-forming temperature (MFT). The polymer film comprises all constituents of the polymer dispersion that are non-volatile at the drying temperature.

Latently reactive preparations of dispersion polymers that comprise solid isocyanates as crosslinking agents or which are mixed with such solid isocyanates and applied as the disperse phase of a dispersion on substrates are known.

EP-A 0 922 720 discloses the use of at least one essentially aqueous dispersion that comprises at least one solid, surface-deactivated polyisocyanate and at least one isocyanate-reactive polymer, for the production of dried, storage-stable, latently reactive layers or powders.

WO2020035573A1 describes an adhesive formulation consisting of at least one polyurethane dispersion, a surface-deactivated solid isocyanate and a polycarbodiimide. The adhesive formulations are used immediately after drying for bonding of substrates, especially of shoe soles; there is no mention of intermediate storage of the dried adhesive films. It is stated explicitly that thermal activation should immediately follow the drying of the adhesive.

In principle, all solid isocyanates can be used according to this teaching. However, it has been shown that when (partially) crystalline polyurethane dispersion polymers are used, two solid isocyanates can be used by preference: TDI dimer and IPDI trimer. Both isocyanates are readily soluble in the molten polyurethane dispersion polymers and have good compatibility therewith, which is advantageously necessary for uniform and good crosslinking of the adhesive polymer.

However, both solid isocyanates have drawbacks in some respects:

As soon as the TDI dimer dissolves in the molten polyurethane polymer, the TDI dimer begins to redissociate to give the TDI monomer (2,4-TDI). 2,4-TDI is highly volatile and can be released from the adhesive layer, for example through porous substrates (textile), into the headspace above the adhesive bond. 2,4-TDI is a hazardous substance that, according to GHS (Globally Harmonized System of Classification, Labelling and Packaging of Chemicals), must be labeled GHS06 on account of its acute toxicity and GHS08 on account of various health hazards.

According to the teaching of EP-A 1 600 485, the release of 2,4-TDI can be considerably reduced through the additional use of catalysts. However, it has been found that the release of 2,4-TDI cannot be reliably reduced to amounts below the detection limit. Consequently, latently reactive adhesive layers that comprise TDI dimer as solid isocyanate are not used in, for example, bonding processes for add-on components in automobile interiors (dashboard, door side panel).

A disadvantage of IPDI trimer is that its aqueous formulations have only limited storage stability. For example, the maximum storage time of aqueous formulations comprising IPDI trimer is only 1-2 months at 23° C., approx. 2 weeks at 30° C. and only approx. 1 week at 35° C. Moreover, IPDI trimer is considerably less reactive than TDI dimer and is therefore processed almost exclusively with the additional use of suitable catalysts (see EP-A 2 099 840 A1 and WO 2008/071307).

There is therefore a demand in the adhesive processing industry for new storage-stable aqueous adhesive systems from which it is possible to produce latently reactive adhesive layers and films. The crosslinking agents used should be physiologically harmless, should not decompose during processing of the adhesive polymer, should have adequately high reactivity and should be stable to sedimentation in aqueous adhesives.

It was an object of the present invention to provide an aqueous polyurethane dispersion for production of storage-stable and latently reactive adhesives that does not require the use of solid isocyanates and/or solid polycarbodiimides.

This object is achieved by the inventive use of an aqueous dispersion for production of storage-stable and latently reactive adhesives, wherein the aqueous dispersion contains at least the following dispersed components:
(A) at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C).

A further object was that of providing a method of bonding at least two substrates or at least two surface regions of a substrate.

This object is achieved by the method according to the invention for bonding of at least two substrates or at least two surface regions of a substrate, comprising at least the steps of
(i) providing an aqueous dispersion containing at least the following dispersed components:
(A) at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C),
(ii) applying the aqueous dispersion from step (i) on at least a portion of at least one surface or a surface region of the at least one substrate, or to a suitable carrier medium for production of self-supporting adhesive films,
(iii) drying the at least one dispersion present from step (ii) in order to obtain at least one storage-stable and latently reactive adhesive layer or a storage-stable and latently reactive self-supporting adhesive film,
(iv) storing the at least one substrate or the self-supporting adhesive film from step (iii) for a period of at least 8 hours, preferably of 8 hours to 2400 hours, more preferably of 8 hours to 168 hours, at a temperature in the range from −40° C. to 30° C., and
(v) contacting the at least one storage-stable and latently reactive adhesive layer with at least one further surface region of the at least one substrate, with at least a portion of a further substrate or with at least a portion of an adhesive layer present on a further substrate, at a temperature in the range from 40° C. to 200° C., preferably from 50 to 120° C., more preferably from 55 to 100° C., or contacting the self-supporting adhesive film with at least two substrates at a temperature in the range from 40° C. to 200° C., preferably from 50 to 120° C., more preferably from 55 to 100° C.

It has been found that, surprisingly, the described dispersions according to the invention are suitable for production of storage-stable and latently reactive adhesives, even though these adhesives contain polycarbodiimides having a very low glass transition temperature and polyurethane dispersions containing carboxyl groups. These adhesives may still be used for bonding of different substrates even after several months, for example by the thermal activation method. It has also been found that, surprisingly, the described dispersions according to the invention are suitable in bonding methods for binding of at least two substrates or at least two surface regions of a substrate in which latently reactive adhesives are used.

The word “a” in the context of the present invention in association with countable parameters should be understood to mean the number “one” only when this is stated explicitly (for instance by the expression “exactly one”). When reference is made hereinbelow for example to “a polyisocyanate”, the word “a” should be regarded merely as the indefinite article and not the number one; this also therefore encompasses an embodiment in which two or more, for example structurally dissimilar, polyisocyanates are present.

“Polyurethane polymer” in the context of the invention means both polyurethane polymers and polyurethane-urea polymers or polyurethane-polyurea polymers.

“Aqueous dispersion” in the context of the invention means an aqueous dispersion, aqueous emulsion, aqueous suspension, or an intermediate state/intermediate form thereof, preferably an aqueous dispersion, aqueous emulsion and/or aqueous suspension.

More preferably, the term “dispersion” means an aqueous emulsion and/or an aqueous suspension. The term “polyurethane dispersion” refers both to polyurethane dispersions and polyurethane(poly) urea dispersions.

“Open time” in the context of the invention means the time after the drying of an adhesive during which the adhesive is still capable of sufficient flow under the customary conditions in heat-induced bonding and wetting of a substrate to be bonded is still possible under moderate pressure, such that, for example, a high bond strength of bonded substrates can be achieved.

In the context of the invention, it is a feature of storage-stable preliminary coatings on substrate surfaces, storage-stable adhesives, storage-stable adhesive layers, self-supporting storage-stable adhesive films and/or storage-stable adhesive powders that, after storage under standard conditions (23° C., 50% relative humidity) after more than 24 h, more preferably after more than 7 d, they are still capable of sufficient flow under the customary conditions in heat-induced bonding, and wetting of a substrate to be bonded is still possible under moderate pressure.

Typically, in heat-induced bonding, the adhesive is heated to a temperature between 4° and 120° C., and the substrates are pressed with a moderate pressure, for example 0.5 to 10 bar.

“Latently reactive adhesive” in the context of the invention means an adhesive having bonds containing functional groups that can enter into a reaction with one another, and the reaction of which can be induced or accelerated by increasing the temperature to, but preferably above, the melting temperature of component (A), which leads to crosslinking and hence a rise in thermal stability of the crosslinked adhesive.

According to the invention, a polymer, especially polyurethane polymer, is referred to as being crystalline when it has a melting peak in the first heating run in DSC analysis according to DIN EN ISO 11357-1:2017 (2017-02) at a heating rate of 20 K/minute. The melting peak is caused by the melting of regular substructures in the polymer, especially polyurethane polymer. According to the invention, a polymer, especially polyurethane polymer, is referred to as being semicrystalline when it has a melting peak in the first heating run and has a glass transition in the third heating run in DSC analysis according to DIN EN ISO 11357-1:2017 (2017-02) at a heating rate of 20 K/minute.

The melting temperature of the polyurethane polymer (A) containing at least one semicrystalline or crystalline carboxyl group which is present in the aqueous dispersion according to the invention is in the range from 35 to 80° C., preferably 40 to 70° C., more preferably 42 to 55° C. The enthalpy of fusion of the at least one semicrystalline or crystalline polyurethane polymer (A) containing carboxyl groups is ≥15 J/g. The at least one polycarbodiimide and the at least one polyaziridine have a glass transition temperature of in the range from −150° C. to 30° C. Melting temperature and enthalpy of fusion are ascertained in the first heating run proceeding from a starting temperature of −100° C. in DSC analysis according to DIN EN ISO 11357-1:2017 (2017-02) at a heating rate of 20 K/min. The glass transition temperature is ascertained in the third heating run proceeding from a starting temperature of −180° C. in DSC analysis according to DIN EN ISO 11357-1:2017 (2017-02) at a heating rate of 20 K/min. In the case of application of DIN EN ISO 11357-1:2017 (2017-02), the part of the standard concerning determination of the glass transition temperature is DIN EN ISO 11357-2:2020-08, and the part of the standard concerning determination of melting temperature and enthalpy of fusion is DIN EN ISO 11357-3:2018-07. For the DSC analysis of polymers in aqueous dispersion, a sample is taken from a polymer film that has been dried to constant weight at 23° C. and 50% relative humidity and then stored in a drying box at 0% relative humidity for 3 days.

According to the invention, the expressions “comprising” or “containing” preferably mean “consisting essentially of” and more preferably mean “consisting of”. It should be noted that the features adduced individually in the claims can be combined with one another in any technically useful way (even across category boundaries, for example between method and use) and demonstrate further configurations of the invention. The description additionally characterizes and specifies the invention.

It should also be noted that any conjunction “and/or” used herein between two features and linking them to one another should always be interpreted such that in a first configuration of the subject matter of the invention only the first feature can be present, in a second configuration only the second feature can be present, and in a third configuration both the first and the second feature can be present.

In a preferred embodiment, the storage-stable and latently reactive adhesives are storage-stable and latently reactive adhesive layers, self-supporting, storage-stable and latently reactive adhesive films and/or storage-stable and latently reactive adhesive powders. In a preferred embodiment, the adhesive layers and/or adhesive films are present on a substrate, where the substrate is preferably selected from the group consisting of wood, paper, thermoplastics, elastomeric polymers, thermoplastic-elastomeric polymers, vulcanizates, textile fabrics, knits, braids, leather, metals, ceramic, asbestos cement, stoneware, concrete, foams and/or combinations of at least two of these.

In a preferred embodiment, the adhesives and/or the adhesive layer have a storage stability of more than 14 days at a temperature of 23° C., preferably more than 28 days, more preferably a storage stability in the range from 14 days to 365 days at a temperature of 23° C.

In a preferred embodiment, the adhesives and/or the adhesive layer have an enthalpy of fusion of ≥15 J/g, preferably in the range from 15 J/g to 100 J/g, more preferably in the range from 20 J/g to 60 J/g, determined by DSC (differential scanning calorimetry) DIN EN ISO 11357-1 (2017-02).

In a preferred embodiment, the aqueous dispersion has a partial acid number in the range from 0.5 mg KOH/g to 10 mg KOH/g, preferably in the range from 1.0 mg KOH/g to 10 mg KOH/g, more preferably in the range from 2 mg KOH/g to 6 mg KOH/g, determined in accordance with DIN EN ISO 2114:2000 (2002-06, Method A with an acetone-ethanol solvent mixture).

In a preferred embodiment, the molar ratio of carbodiimide groups (—N═C═N—) to carboxyl groups (—COOH) in component A is in the range from 0.2:1 to 5:1, preferably in the range from 0.5:1 to 2.9:1.

In a preferred embodiment, the aqueous dispersion contains
40% by weight to 99.5% by weight, preferably 70% by weight to 98.5% by weight, of component (A),
0.5% by weight to 40% by weight, preferably 1.5% by weight to 30% by weight, of component (B), and
0% by weight to 50% by weight, preferably 0% by weight to 28.5% by weight, of component (C), and the proportions of (A), (B) and (C) add up to 100% by weight.

In a preferred embodiment, the aqueous dispersion according to the invention contains organic solvents in a concentration of ≤5% by weight, preferably ≤1% by weight, based on the total weight of the aqueous adhesive formulation. In a further preferred embodiment, the aqueous dispersion according to the invention does not contain any acetone and/or organic polar aprotic solvents.

The individual components of the components present in the aqueous dispersion according to the invention are described in detail below.

In a preferred embodiment, at least two of components (A) and optionally (C) may be present collectively as a polymer hybrid, meaning that there are at least two different polymer chains in a particle that are not connected to one another (core-shell polymer particles). One example of a polymer hybrid is a polyurethane-vinyl polymer hybrid consisting partly of a polyurethane polymer and a polyacrylate polymer. In this example, depending on the polymer properties, the polyacrylate polymer would be component (C) and the polyurethane polymer would be component (A). The polymer hybrid is preferably a polyurethane-vinyl polymer hybrid. In a polyurethane-vinyl polymer hybrid, the vinyl polymer is preferably component (C) and the polyurethane polymer is component (A). A polyurethane-vinyl polymer hybrid is obtainable, for example, by the in situ production of a vinyl polymer by polymerization of one or more vinyl monomers in the presence of a ready-made aqueous polyurethane dispersion. A polyurethane-vinyl polymer hybrid (also referred to hereinafter as polyurethane-vinyl polymer) is understood to mean that a vinyl polymer is prepared by free-radical polymerization of vinyl monomer(s) in the presence of the polyurethane or starting materials thereof, i.e. at least one polyisocyanate and at least one polyol. The vinyl monomer may be added before, during and/or after the preparation of the polyurethane. The vinyl monomer is polymerized by adding an initiator that affords free radicals, in order polymerize the vinyl monomer, for example in the presence of the polyurethane. Suitable free-radical-forming initiators are well known in the art and include mixtures that are distributed between the aqueous and organic phases. A vinyl monomer in this connection does not mean a single vinyl monomer but an embodiment of a vinyl monomer, for example vinyl acetate.

### Component (A)

The aqueous dispersion according to the invention contains, as component (A), at least one semicrystalline or crystalline polyurethane polymer containing carboxyl groups which has a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture).

If two or more polymers are present as component (A), the mixture of these polymers has an average partial acid number in the range from 0.8 mg KOH/g to 25 mg KOH/g, determined in accordance with DIN EN ISO 2114:2000 (2002-06, Method A with an acetone-ethanol solvent mixture), preferably where each of the polymers in the mixture has a partial acid number of in the range from 0.8 mg KOH/g to 25 mg KOH/g, determined in accordance with DIN EN ISO 2114:2000 (2002-06, Method A with an acetone-ethanol solvent mixture).

If two or more polymers are present as component (A), the mixture of these polymers has an average melting temperature in the range from 35 to 80° C. and an enthalpy of fusion of ≥15 J/g, in each case determined by DSC (differential scanning calorimetry) at a heating rate of 20 K/min in accordance with DIN EN ISO 11357-1:2017 (2017-02), where it is preferable that each of the polymers in the mixture has a melting temperature in the range from 35 to 80° C. and an enthalpy of fusion of ≥15 J/g, in each case determined by DSC (differential scanning calorimetry) at a heating rate of 20 K/min in accordance with DIN EN ISO 11357-1:2017 (2017-02).

The polyurethane suitable as component (A) is preferably film-forming, preferably film-forming with a minimum film formation temperature according to DIN ISO 2115:2001-04 in the range from 0 to 100° C., more preferably between 0 and 35° C., and may, for example, be a single polyurethane containing carboxyl groups, for a mixture of at least two different polyurethanes containing carboxyl groups.

The crosslinking reaction with carbodiimide groups is preferably effected predominantly or exclusively via the incorporated carboxyl groups in the polyurethane suitable as component (A).

Suitable components (A) are all semicrystalline or crystalline polyurethane polymers containing carboxyl groups that are known to the person skilled in the art and have a melting temperature in the range of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture). A polyurethane polymer suitable as component (A) is generally one or more polyurethanes in the narrower sense, i.e. polymers obtained by polymerization of polyols and polyisocyanates, but they may also be ones in which monoamines and/or diamines are used as formation components, optionally as chain extenders. In the context of the present invention, the polyurethane polymer of component (A) is thus generally at least one polyurethane, at least one polyurea and/or at least one polyurethane-urea.

The polyurethane polymers suitable as component (A) or the aqueous polyurethane or polyurethaneurea dispersions thereof are typically reaction products of
(A1) at least one diol component and/or polyol component;
(A2) at least one di- and/or polyisocyanate component;
(A3) at least one isocyanate-reactive component having at least one free carboxyl group, where the isocyanate-reactive component preferably has up to two amino and/or hydroxyl groups and one free carboxyl group, where the isocyanate-reactive component (A3) is different from components (A1), (A2), (A4) and (A5);
(A4) optionally at least one component having neutralized sulfonic acid group and having isocyanate-reactive groups, where the isocyanate-reactive groups are preferably up to two amino and/or hydroxyl groups, where component (A4) is different from components (A1), (A2), (A3) and (A5);
(A5) optionally at least one component selected from the group consisting of a mono-aminofunctional compound, di-amino-functional compound, tri-amino-functional compound, and/or a mixture of at least two of these, where component (A5) is different from components (A1), (A2), (A3) and (A4).

Component (A1) is typically used in amounts of 20% by weight to 94% by weight, preferably 20% by weight to 90% by weight, based on the total weight of the polyurethane polymer (A).

Component (A2) is typically used in amounts of 5% by weight to 65% by weight, preferably 5% by weight to 60% by weight, based on the total weight of the polyurethane polymer (A).

Component (A3) is typically used in amounts of 0.25% by weight to 15% by weight, preferably 0.25% by weight to 10% by weight, based on the total weight of the polyurethane polymer (A).

Component (A4) is typically used in amounts of 0% by weight to 10% by weight, preferably 0.5% by weight to 8% by weight, based on the total weight of the polyurethane polymer (A).

Component (A5) is typically used in amounts of 0% by weight to 10% by weight, preferably 0% by weight to 5% by weight, based on the total weight of the polyurethane polymer (A).

The proportions of components (A1), (A2), (A3), (A4) and (A5) add up to 100% by weight. It will be apparent in the context of the invention that the above-described components (A1) to (A5) and the typical and preferred amounts thereof also include all combinations of the individually specified ranges of amount with one another.

Suitable diol and/or polyol components (A1) are compounds having at least two isocyanate-reactive hydrogen atoms and an average molecular weight (Mn) in the range from 62 to 18 000 and preferably in the range from 62 to 6000 g/mol, more preferably in the range from 400 to 6000 g/mol, determined in accordance with DIN EN ISO 13885-1 (2021-11) with tetrahydrofuran as eluent and polystyrene as standard. Examples of suitable formation components are polyethers, polyesters, polycarbonates, polylactones and polyamides. Preferred polyols (A1) have 2 to 4 and more preferably 2 to 3 hydroxyl groups. Mixtures of various such compounds are also possible.

Crystalline or semicrystalline difunctional polyester polyols that are suitable as formation component (A1) in component (A) are in particular linear polyester diols or also sparsely branched polyester polyols, as can be produced in a known manner from aliphatic, cycloaliphatic or aromatic di- or polycarboxylic acids such as succinic acid, methylsuccinic acid, glutaric acid, adipic acid, pimelic acid, suberic acid, azelaic acid, sebacic acid, nonanedicarboxylic acid, decanedicarboxylic acid, terephthalic acid, isophthalic acid, o-phthalic acid, tetrahydrophthalic acid, hexahydrophthalic acid, cyclohexanedicarboxylic acid, maleic acid, fumaric acid, malonic acid or trimellitic acid and acid anhydrides such as o-phthalic, trimellitic or succinic anhydride or mixtures thereof with polyhydric alcohols, such as ethanediol, di-, tri-, tetraethylene glycol, propane-1,2-diol, di-, tri-, tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol or mixtures thereof, optionally with the additional use of higher-functional polyols such as trimethylolpropane, glycerol or pentaerythritol. Cycloaliphatic and/or aromatic di- and polyhydroxyl compounds are of course also suitable as polyhydric alcohols for producing the polyester polyols. In place of the free polycarboxylic acid, it is also possible to use for the production of the polyesters the corresponding polycarboxylic anhydrides or corresponding polycarboxylic esters of lower alcohols or mixtures thereof.

It will be apparent that the polyester polyols may also be homopolymers or copolymers of lactones, which are obtained preferably by adding lactones or lactone mixtures, such as butyrolactone, ε-caprolactone and/or methyl-8-caprolactone, to the suitable di- and/or higher-functional starter molecules, such as the low molecular weight, polyhydric alcohols mentioned above as formation components for polyester polyols. Preference is given to the corresponding polymers of ε-caprolactone.

Particular preference is given to largely linear polyester polyols which contain adipic acid and/or sebacic acid and/or decanedicarboxylic acid and butane-1,4-diol and/or hexane-1,6-diol as formation components.

If the crystalline or semicrystalline difunctional polyester polyols having a number-average molecular weight of at least 400 g/mol and a melting temperature of at least 35° C. have an enthalpy of fusion of at least 50 J/g, the polymer prepared using these will regularly have an enthalpy of fusion of ≥15 J/g. If desired, adjustment of the enthalpy of fusion of the polymer can be achieved by a slight variation in the content of polyester polyol (A1) in the composition or by a small variation of the enthalpy of fusion of the polyester polyol. These measures require only exploratory tests and are completely within the practical experience of a person of average skill in the art in this field.

The production of polyester polyols (A1) is known from the prior art.

The melting temperature of the crystalline or semicrystalline polyester polyols is generally at least 35° C., preferably 40 to 80° C., more preferably 42 to 60° C. The enthalpy of fusion is ≥15 J/g, preferably ≥40 J/g, and more preferably ≥50 J/g.

Preferably, component (A1) is at least one difunctional, semicrystalline or crystalline, aliphatic polyester polyol having a molecular weight (Mn) in the range from 400 to 6000 g/mol, determined in accordance with DIN EN ISO 13885-1 (2021-11) with tetrahydrofuran as eluent and polystyrene as standard.

Polycarbonates comprising hydroxyl groups are also suitable as polyhydroxyl components, for example those which can be produced by reacting diols, such as butane-1,4-diol and/or hexane-1,6-diol, with diaryl carbonates such as diphenyl carbonate, dialkyl carbonates such as dimethyl carbonate, or phosgene. The at least partial use of polycarbonates having hydroxyl groups can improve the resistance to hydrolysis of the polyurethane or polyurethane-urea dispersion adhesives.

Preference is given to polycarbonates which are prepared by reacting hexane-1,6-diol with dimethyl carbonate.

Examples of suitable polyether polyols are the polyaddition products of styrene oxides, of ethylene oxide, propylene oxide, tetrahydrofuran, butylene oxide, epichlorohydrin, and mixed addition and grafting products thereof, and also the polyether polyols obtained by condensation of polyhydric alcohols or mixtures of the same and obtained by alkoxylation of polyhydric alcohols, amines, and amino alcohols. Polyether polyols suitable as formation components A) are homopolymers, copolymers, and graft polymers of propylene oxide and of ethylene oxide that are obtainable by addition of the epoxides mentioned onto low molecular weight diols or triols, such as those mentioned above as formation components for polyester polyols, or those obtainable from higher-functional low molecular weight polyols such as pentaerythritol or sugar, or to water.

Particularly preferred difunctional or higher-functional polyols (A1) are polyester polyols and polycarbonates. And the noncrystalline difunctional polyester polyols are preferably only in a minor amount.

Likewise suitable components (A1) are low molecular weight diols, triols and/or higher alcohols, for example ethanediol, di-, tri-, tetraethylene glycol, propane-1,2-diol, di-, tri-, tetrapropylene glycol, propane-1,3-diol, butane-1,4-diol, butane-1,3-diol, butane-2,3-diol, pentane-1,5-diol, hexane-1,6-diol, 2,2-dimethylpropane-1,3-diol, 1,4-dihydroxycyclohexane, 1,4-dimethylolcyclohexane, octane-1,8-diol, decane-1,10-diol, dodecane-1,12-diol, neopentyl glycol, cyclohexane-1,4-diol, cyclohexane-1,4-dimethanol, 1,4-, 1,3-, 1,2-dihydroxybenzene or 2,2-bis(4-hydroxyphenyl)propane (bisphenol A), tricyclodecanedimethanol, trimethylolpropane, glycerol, pentaerythritol, dipentaerythritol or mixtures thereof, optionally with additional use of other diols or triols not mentioned. These low molecular weight diols, triols and/or higher alcohols should preferably be used only in a minor amount, more preferably less than 10% by weight of the overall component A1).

The low molecular weight components (A1) have a molecular weight of 62 to 400 g/mol and are preferably used in combination with the polyester polyols, polylactones, polyethers, and/or polycarbonates described above.

Polyol component (A1) is present in the polyurethane polymer suitable as component (A) preferably to an extent of 20% by weight to 94% by weight, more preferably to an extent of 20% by weight to 90% by weight, based on the total weight of the polyurethane polymer (A).

Suitable components (A2) include any desired organic compounds having at least two free isocyanate groups per molecule. Preference is given to using diisocyanates Y(NCO)₂ where Y is a divalent aliphatic hydrocarbyl radical having 4 to 12 carbon atoms, a divalent cycloaliphatic hydrocarbyl radical having 6 to 15 carbon atoms, a divalent aromatic hydrocarbyl radical having 6 to 15 carbon atoms or a divalent araliphatic hydrocarbyl radical having 7 to 15 carbon atoms. Examples of such diisocyanates that are to be used with preference include tetramethylene diisocyanate, pentamethylene diisocyanate, methylpentamethylene diisocyanate, hexamethylene diisocyanate, dodecamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanato-2,2-dicyclohexylpropane, 1,4-diisocyanatobenzene, 2,4-diisocyanatotoluene, 2,6-diisocyanatotoluene, 4,4′-diisocyanatodiphenylmethane, 2,2′- and 2,4′-diisocyanatodiphenylmethane, tetramethylxylylene diisocyanate, p-xylylene diisocyanate, p-isopropylidene diisocyanate, and mixtures consisting of these compounds.

It will be appreciated that it is also possible to additionally use proportions of higher-functionality polyisocyanates known per se in polyurethane chemistry, or else modified polyisocyanates known per se and for example comprising carbodiimide groups, allophanate groups, isocyanurate groups, urethane groups and/or biuret groups.

In addition to these simple diisocyanates, polyisocyanates containing heteroatoms in the radical linking the isocyanate groups and/or having a functionality of more than 2 isocyanate groups per molecule are also suitable. The former are, for example, polyisocyanates which have been produced by modification of simple aliphatic, cycloaliphatic, araliphatic and/or aromatic diisocyanates, are formed from at least two diisocyanates, and have a uretdione, isocyanurate, urethane, allophanate, biuret, carbodiimide, iminooxadiazinedione and/or oxadiazinetrione structure. An example of an unmodified polyisocyanate having more than 2 isocyanate groups per molecule is 4-isocyanatomethyloctane 1,8-diisocyanate (nonane triisocyanate).

Preferably, component (A2) is at least one diisocyanate selected from the group consisting of hexamethylene diisocyanate (HDI), 1-isocyanato-3,3,5-trimethyl-5-isocyanatomethylcyclohexane (IPDI), toluene 2,4-diisocyanate (TDI), pentamethylene diisocyanate (PDI) and/or a mixture of at least two of these.

Particularly preferred diisocyanates (A2) are aliphatic and cycloaliphatic diisocyanates such as hexamethylene diisocyanate, 1,4-diisocyanatocyclohexane, 1-isocyanato-3,3,5-trimethyl-5-isocyanatomethylcyclohexane, 4,4′-diisocyanatodicyclohexylmethane, 4,4′-diisocyanatodicyclohexylpropane-(2,2), pentamethylene diisocyanate, and mixtures consisting of these compounds.

Very particularly preferred components (A2) are mixtures of hexamethylene diisocyanate and 1-isocyanato-3,3,5-trimethyl-5-isocyanatomethylcyclohexane, pentamethylene diisocyanate, and mixtures of 1-isocyanato-3,3,5-trimethyl-5-isocyanatomethylcyclohexane and/or 4,4′-diisocyanatodicyclohexylmethane and/or 2,4-diisocyanatotoluene and/or 2,6-diisocyanatotoluene.

Component (A2) is present in the polyurethane polymer suitable as component (A) preferably in amounts of 5% by weight to 65% by weight, more preferably of 5% by weight to 60% by weight, based on the total weight of the polyurethane polymer (A).

As component (A3), compounds containing carboxyl groups that are suitable as formation component for polyurethane polymer (A) used in accordance with the invention are, for example, diamino compounds or dihydroxyl compounds that additionally bear carboxyl groups. Examples of such compounds are dimethylolpropionic acid, dimethylolbutyric acid and/or reaction products of a Michael addition of 1 mol of diamine, for example ethane-1,2-diamine or isophoronediamine, with 2 mol of acrylic acid or maleic acid.

More preferably suitable as unit containing carboxyl groups (A3) in component (A) is dimethylolpropionic acid.

Further compounds containing carboxyl groups that are suitable as component (A3) for the polyurethane polymer (A) used in accordance with the invention are, for example, aminocarboxylic acids that contain at least one isocyanate-reactive amino group, and hence are suitable for incorporation into the polymer in the preparation of the polyurethane polymers suitable as component (A) by reaction with component (A3). Linear aliphatic, branched aliphatic, aliphatic-aromatic, and aromatic aminocarboxylic acids are suitable. Examples of suitable compounds include aminocarboxylic acids having a primary or secondary amino group, such as alanine, lysine, glutamine, 6-aminohexanoic acid, aminoundecanoic acid, 8-aminooctanoic acid, 5-aminopentanoic acid, 4-aminobutyric acid, aminobenzoic acid, 4-aminomethylcyclohexanecarboxylic acid, 2-aminohexanoic acid, 4-aminocyclohexanoic acid, 12-aminododecanoic acid, 9-aminononacarboxylic acid.

Carboxyl group-containing units (A3) used in component (A) are preferably aminocarboxylic acids and more preferably aminoalkylcarboxylic acids such as 6-aminohexanoic acid and/or lysine, which are present in the polymer in a form incorporated via the amino group.

The units having carboxyl groups may partly also be used directly in their salt form or as carboxylate, or it is possible to add neutralizing agents that lead to salt formation only during or after production of the polyurethanes.

Examples of particularly suitable and preferred tertiary amines for salt formation are triethylamine, dimethylcyclohexylamine, and ethyldiisopropylamine. Particular preference is given to using triethylamine.

Other amines may also be used for salt formation, for example ammonia, diethanolamine, triethanolamine, dimethylethanolamine, methyldiethanolamine, aminomethylpropanol and also mixtures of the recited amines and also other amines. It is advisable to add these amines only after the isocyanate groups have been largely converted.

It is also possible to use, for neutralization purposes, proportions of other neutralizing agents, for example sodium hydroxide, potassium hydroxide and/or lithium hydroxide. The type and amount of any neutralizing agents used should be chosen such that there are still carboxyl groups in the polymer used as component (A).

Preferably, component (A3) is at least one isocyanate-reactive component selected from the group consisting of aminocarboxylic acids, hydroxycarboxylic acids and/or a mixture of at least two of these, preferably selected from the group consisting of dimethylolpropionic acid, dimethylolbutyric acid, lysine and/or a mixture of at least two of these.

Component (A3) is present in the polyurethane polymer suitable as component (A) preferably in amounts of 0.25% by weight to 15% by weight, more preferably of 0.25% by weight to 10% by weight, based on the total weight of the polyurethane polymer (A).

Suitable sulfonate-containing components (A4) are, for example, diamino compounds or dihydroxyl compounds that additionally bear sulfonate and/or carboxylate groups, for example the sodium, lithium, potassium or tertiary amine salts of N-(2-aminoethyl)-2-aminoethanesulfonic acid, of N-(3-aminopropyl)-2-aminoethanesulfonic acid, of N-(3-aminopropyl)-3-aminopropanesulfonic acid, of N-(2-aminoethyl)-3-aminopropanesulfonic acid.

A preferred component (A4) is N-(2-aminoethyl)-2-aminoethanesulfonate.

The compounds are preferably used directly in their salt form, as the sulfonate. However, it is also possible for some or all of the neutralizing agents necessary for salt formation not to be added until during or after production of the polyurethanes.

Component (A4) is present in the polyurethane polymer suitable as component (A) preferably to an extent of 0% by weight to 10% by weight, more preferably to an extent of 0.5% by weight to 8% by weight, based on the total weight of the polyurethane polymer (A).

Suitable components (A5) are mono-, di-, trifunctional amines and/or mono-, di-, trifunctional hydroxylamines, for example aliphatic and/or alicyclic primary and/or secondary monoamines such as ethylamine, diethylamine, the isomeric propyl- and butylamines, higher linear aliphatic monoamines and cycloaliphatic monoamines such as cyclohexylamine. Further examples are amino alcohols, i.e. compounds containing amino and hydroxyl groups in the same molecule, for example ethanolamine, N-methylethanolamine, diethanolamine, diisopropanolamine, 1,3-diamino-2-propanol, N-(2-hydroxyethyl)ethylenediamine, N,N-bis(2-hydroxyethyl)ethylenediamine, and 2-propanolamine. Further examples are diamines and triamines, such as ethane-1,2-diamine, hexamethylene-1,6-diamine, 1-amino-3,3,5-trimethyl-5-aminomethylcyclohexane (isophoronediamine), piperazine, 1,4-diaminocyclohexane, bis(4-aminocyclohexyl)methane, and diethylenetriamine. Also suitable are adipic dihydrazide, hydrazine and hydrazine hydrate. It will be appreciated that it is also possible to use mixtures of two or more of the compounds (A5) mentioned, optionally also together with ones that are not mentioned.

Preferred components (A5) are ethane-1,2-diamine, 1-amino-3,3,5-trimethyl-5-aminomethylcyclohexane, diethylenetriamine, diethanolamine, ethanolamine, N-(2-hydroxyethyl)ethylenediamine and N,N-bis(2-hydroxyethyl)ethylenediamine.

Components (A5) as chain extenders preferably serve to increase molecular weights to higher levels, or as monofunctional compounds to limit molecular weights and/or optionally additionally to incorporate additional reactive groups, for example free hydroxyl groups, as further crosslinking sites.

Preferably, component (A5) is at least one component selected from the group consisting of a mono-amino-functional compound, di-amino-functional compound, tri-amino-functional compound, and/or a mixture of at least two of these, where component (A5) is different from components (A1), (A2), (A3) and (A4).

Preferably, component (A5) is a component selected from the group consisting of monoethanolamine, diethanolamine, hydroxyethylethanediamine and/or a mixture of at least two of these.

Component (A5) is present in the polyurethane polymer suitable as component (A) preferably in amounts of 0% by weight to 10% by weight, more preferably of 0% by weight to 5% by weight, based on the total weight of the polyurethane polymer (A).

Further details of the preparation of a polyurethane containing carboxyl groups can be found in patent specification EP3502157A1 and EP2186841A1 and EP3795601A1.

The polyurethane polymers suitable as component (A) may be present and used in solid or solution form or as a dispersion in a liquid medium. The polyurethane polymers are preferably provided as aqueous dispersions. Such polyurethane dispersions suitable as component (A) preferably include nonvolatile fractions of 15% by weight to 70% by weight, preferably of 20% by weight to 60% by weight, based on the total weight of the aqueous dispersion. The pH is preferably in the range from 4 to 11, more preferably 5 to 8, at a temperature of 23° C. Average particle sizes measured by laser diffraction to ISO 13320 (laser diffraction) with the Malvern Mastersizer 3000 are typically in the range from 20 nm to 750 nm, preferably in the range from 30 nm to 450 nm.

Polyurethane dispersions suitable as component (A) are preferably anionically stabilized polyurethane dispersions. One example of a commercially available polyurethane dispersion suitable as component (A) is Dispercoll® U 2824 from Covestro Deutschland AG.

In a preferred embodiment, the at least one polyurethane polymer (A) has an average molecular weight (Mw) in the range from 20 000 g/mol to 300 000 g/mol, preferably in the range from 20 000 g/mol to 200 000 g/mol, more preferably in the range from 20 000 g/mol to 100 000 g/mol, even more preferably in the range from 40 000 g/mol to 80 000 g/mol, determined in accordance with DIN EN ISO 13885-2 (2021-11) with N,N-dimethylacetamide as eluent and polystyrene as standard.

In a preferred embodiment, the polyurethane polymer (A) has a partial acid number in the range from 2.5 mg KOH/g to 25 mg KOH/g, preferably in the range from 2.5 mg KOH/g to 12.5 mg KOH/g, determined in accordance with DIN EN ISO 2114:2000 (2002-06, Method A with an acetone-ethanol solvent mixture).

In a preferred embodiment, the polyurethane polymer (A) is obtainable or obtained by the reaction of the following components:
(A1) at least one diol component and/or polyol component;
(A2) at least one di- and/or polyisocyanate component;
(A3) at least one isocyanate-reactive component having at least one free carboxyl group, where the isocyanate-reactive component preferably has up to two amino and/or hydroxyl groups and one free carboxyl group, where the isocyanate-reactive component (A3) is different from components (A1), (A2), (A4) and (A5);
(A4) optionally at least one component having neutralized sulfonic acid groups and having isocyanate-reactive groups, where the isocyanate-reactive groups are preferably up to two amino and/or hydroxyl groups, where component (A4) is different from components (A1), (A2), (A3) and (A5);
(A5) optionally at least one component selected from the group consisting of a mono-amino-functional compound, di-amino-functional compound, tri-amino-functional compound, and/or a mixture of at least two of these, where component (A5) is different from components (A1), (A2), (A3) and (A4).

In a preferred embodiment, the polyurethane polymer (A) is obtainable or obtained by the reaction of the following components:
(A1) at least one difunctional, semicrystalline or crystalline, aliphatic polyester polyol having a molecular weight (Mn) in the range from 400 to 6000 g/mol, determined in accordance with DIN EN ISO 13885-1 (2021-11) with tetrahydrofuran as eluent and polystyrene as standard;
(A2) at least one diisocyanate selected from the group consisting of hexamethylene diisocyanate (HDI), 1-isocyanato-3,3,5-trimethyl-5-isocyanatomethylcyclohexane (IPDI), toluene 2,4-diisocyanate (TDI), pentamethylene diisocyanate (PDI) and/or a mixture of at least two of these;
(A3) at least one isocyanate-reactive component selected from the group consisting of aminocarboxylic acids, hydroxycarboxylic acids and/or a mixture of at least two of these, preferably selected from the group consisting of dimethylolpropionic acid, dimethylolbutyric acid, lysine and/or a mixture of at least two of these;
(A4) optionally the sodium salt of N-(2-aminoethyl)-2-aminoethanesulfonic acid;
(A5) optionally a component selected from the group consisting of monoethanolamine, diethanolamine, hydroxyethylethanediamine and/or a mixture of at least two of these.

In a preferred embodiment, the polyurethane polymer (A) contains
20% by weight to 94% by weight, preferably 20% by weight to 90% by weight, of component A1;
5% by weight to 65% by weight, preferably 5% by weight to 60% by weight, of component A2;
0.25% by weight to 15% by weight, preferably 0.25% by weight to 10% by weight, of component A3;
0% by weight to 10% by weight, preferably 0.5% by weight to 8% by weight, of component A4;
0% by weight to 10% by weight of component A5,
where the sum total of constituents (A1), (A2), (A3), (A4) and (A5) is 100% by weight,

In a preferred embodiment, the polyurethane polymer (A) is obtainable or obtained by the reaction of components (A1), (A2), (A3), (A4) and (A5) in the following amounts:
20% by weight to 94% by weight, preferably 20% by weight to 90% by weight, of component A1;
5% by weight to 65% by weight, preferably 5% by weight to 60% by weight, of component A2;
0.25% by weight to 15% by weight, preferably 0.25% by weight to 10% by weight, of component A3;
0% by weight to 10% by weight, preferably 0.5% by weight to 8% by weight, of component A4;
0% by weight to 10% by weight of component A5,
where the sum total of constituents (A1), (A2), (A3), (A4) and (A5) is 100% by weight,

In a preferred embodiment, the proportion of component (A) in the aqueous dispersion is 40% by weight to 99.5% by weight, preferably 70% by weight to 98.5% by weight, based on the total proportions of components (A), (B) and (C) as 100% by weight.

### Component (B)

The aqueous dispersion according to the invention contains, as component (B), at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02).

In a preferred embodiment, the aqueous dispersion according to the invention contains, as component (B), at least one polycarbodiimide, where the at least one polycarbodiimide has a glass transition temperature in the range from −150° C. to 30° C., determined by DSC (differential scanning calorimetry) DIN EN ISO 11357-1 (2017-02).

The term “carbodiimide group” or “carbodiimide structural unit” corresponds to the chemical structure —N═C═N—.

According to the invention, polycarbodiimide means compounds containing more than one carbodiimide structural unit.

Suitable polycarbodiimides preferably have the structure of the formula I as part of the molecular structure:

[symbol]

N═C═N—R [symbol] ₙ Formula (I)

in which n is an integer 2 or more, preferably 2 to 50, most preferably 3 to 6; and R is preferably one or more of the following groups: an aliphatic organic group, an alicyclic organic group and an aromatic organic group containing carbon and hydrogen atoms.

Suitable polycarbodiimides can be prepared by commonly known methods, for example by decarboxylating condensation of diisocyanates, for example of aromatic diisocyanates, aliphatic diisocyanates and alicyclic diisocyanates. Preference is given to using one or more of the following diisocyanates: naphthalene 1,5-diisocyanate, diphenylmethane 4,4′-diisocyanate, diphenyldimethylmethane 4,4′-diisocyanate, phenylene 1,3-diisocyanate, phenylene 1,4-diisocyanate, tolylene 2,4-diisocyanate, tolylene 2,6-diisocyanate, hexamethylene diisocyanate, cyclohexane 1,4-diisocyanate, xylene diisocyanate, isophorone diisocyanate, dicyclohexylmethane 4,4′-diisocyanate, methylcyclohexane diisocyanate, tetramethylxylylene diisocyanate, 3,3′,5,5′-tetraisopropyldiphenyl 4,4′-diisocyanate and 1,3,5-triisopropylbenzene 2,4-diisocyanate, optionally also with additional use of monofunctional isocyanates, for example stearyl isocyanate, phenyl isocyanate, butyl isocyanate, hexyl isocyanate or/and higher-functionality isocyanates such as trimers, uretdiones, allophanates, biurets of the diisocyanates mentioned by way of example, and subsequent, simultaneous or else prior reaction with hydrolysing components, for example mono- or difunctional polyethers based on alcohol- or amine-started ethylene oxide polymers or ethylene oxide/propylene oxide copolymers.

Polycarbodiimides having carbodiimide groups that have been prepared from aliphatic, araliphatic and/or cycloaliphatic isocyanate groups are preferred; polycarbodiimides having carbodiimide groups that have been prepared from aliphatic and/or cycloaliphatic isocyanate groups are particularly preferred.

Particularly preferred carbodiimides are obtained by decarboxylating condensation of 1-isocyanato-3,3,5-trimethyl-5-isocyanatomethylcyclohexane and/or 4,4′-diisocyanatodicyclohexylmethane.

For example, a suitable polycarbodiimide is prepared by a decarboxylating condensation proceeding from one or more above-described diisocyanates with use of an organic phosphorus compound or an organometallic compound as catalyst in the absence of a solvent or an inert solvent at a temperature of about 70° C.

The preparation is preferably effected by heating at least one diisocyanate in the presence of a suitable catalyst, for example phospholine oxide, to 100 to 250° C. with elimination of carbon dioxide until the desired degree of conversion has been attained. The progression of the reaction can be followed, for example, via the decrease in concentration of isocyanate groups in the reaction mixture. The reaction mixture containing isocyanate groups which is thus obtained is then reacted with at least one hydroxy-functional polyether based on ethylene oxide or based on ethylene oxide and propylene oxide, optionally with simultaneous or subsequent reaction with further hydroxy- and/or amino-functional and/or other isocyanate-reactive compounds, for example butylglycol, and optionally followed by dispersion, emulsification or dissolution.

The prior art that describes the preparation and stabilization of polycarbodiimides can be found in European patent applications EP 3 502 157 A1 and EP 2 552 982 A2.

Suitable polycarbodiimides are, for example, Carbodilite® SV-02, Carbodilite® V-02-L2 and Carbodilite® E-02 (all from Nisshinbo Industries, Tokyo, Japan), and Desmodur® 2802 from Covestro Deutschland AG. Preferred polycarbodiimides are Desmodur® 2802 and Carbodilite® V-02-L2; Desmodur® 2802 is particularly preferred.

Suitable polyaziridines to be used in accordance with the invention are the compounds known to the person skilled in the art that contain more than one aziridine group reactive with carboxyl groups. Examples of commercially available polyaziridines are PZ-28 and PZ-33 from Poly aziridine, LLC. Medford, N.J., USA, HD-105 from Shanghai Holdenchem CO, Ltd, Shanghai, China, and NeoAdd Pax® 521, NeoAdd Pax® 523, NeoAdd Pax® 524 and Crosslinker CX-100 from Covestro, and Xa ma 7 from ichemco Co, Italy. Particular preference is given to using Crosslinker CX-100 from Covestro (reaction mixture composed of 2-ethyl-2-[[3-(2-methylaziridin-1-yl)propionyl]methyl]propan-1,3-diyl bis(2-methylaziridine-1-propionate) and 2,2-bis({[3-(2-methylaziridin-1-yl)propanoyl]oxy}methyl)butyl 3-[2,2-bis({[3-(2-methylaziridin-1-yl)propanoyl]oxy}methyl)butoxy]propanoate), NeoAdd Pax® 521 and NeoAdd Pax® 523. Even more preferably, NeoAdd Pax®521 and NeoAdd Pax® 523 are used.

The polycarbodiimide and/or the polyaziridine may take the form of and be used as a dispersion, solution, solid or liquid; it is preferably used in the form of an aqueous dispersion.

In a preferred embodiment, component (B) is at least one polycarbodiimide. In a further preferred embodiment, component (B) is at least one hydrophilically modified, dispersible, dispersed or solvent-dissolved polycarbodiimide, component (B) is preferably at least one hydrophilically modified or dispersible or dispersed polycarbodiimide, and component (B) is more preferably at least one hydrophilically modified polycarbodiimide. In a further preferred embodiment, component (B) has an average molecular weight (Mw) in the range from 500 g/mol to 100 000 g/mol, more preferably in the range from 1000 g/mol to 50 000 g/mol, even more preferably in the range from 2000 g/mol to 20 000 g/mol, even more preferably in the range from 2000 g/mol to 5000 g/mol, determined in accordance with DIN EN ISO 13885-1 (2021-11) with tetrahydrofuran as eluent and polystyrene as standard.

In a preferred embodiment, the at least one component (B) is a polycarbodiimide and has a glass transition temperature of in the range from −100° C. to 30° C., preferably in the range from −60° C. to 30° C., more preferably in the range from −50° C. to 29° C., determined by DSC (differential scanning calorimetry) DIN EN ISO 11357-1 (2017-02).

In a preferred embodiment, the at least one polycarbodiimide has a content of carbodiimide groups (—N═C═N—) in the range from 0.5 mmol/g to 5 mmol/g, determined by ATR infrared spectroscopy against a dicyclocarbodiimide standard, based on the total weight of the at least one polycarbodiimide.

In a preferred embodiment, the molar ratio of carbodiimide groups (—N═C═N—) in component (B) to the carboxyl groups (—COOH) in component (A) is in the range from 0.2:1 to 5:1, preferably in the range from 0.5:1 to 2.9:1.

In a preferred embodiment, the proportion of component (B) in the aqueous dispersion is 0.5% by weight to 40% by weight, preferably 1.5% by weight to 30% by weight, based on the total proportions of components (A), (B) and (C) as 100% by weight.

### Component (C)

The aqueous dispersion according to the invention may optionally contain, as component (C), at least one further polymer other than the at least one polymer (A).

Suitable components (C) are, for example, polyvinylester, polyvinylether, polyvinylalcohol, polyethylene, polystyrene, polybutadiene, polyvinylchloride, polyurethane, polyurethane-polyurea, polyurethane-polyacrylate, polyester, polyacrylate and/or copolymers thereof. The polymers suitable as component (C) may be present and used in solid or solution form or as a dispersion in a liquid medium. Preferably as dispersions or emulsions or aqueous or organic solution. Dispersions containing component (C) may also be used collectively in a mixture together with other aqueous or solvent-containing oligomers or polymers. In the case of such mixtures, compatibility must be checked in each case by simple preliminary tests.

In a preferred embodiment, the proportion of component (C) in the aqueous dispersion is 0% by weight to 50% by weight, preferably 0% by weight to 28.5% by weight, based on the total proportions of components (A), (B) and (C) as 100% by weight.

In a preferred embodiment, the at least one further polymer (C) has a partial acid number in the range from 0 mg KOH/g to 1 mg KOH/g, preferably in the range from 0 mg KOH/g to 0.05 mg KOH/g, in each case determined in accordance with DIN EN ISO 2114:2000 (2002-06, Method A with an acetone-ethanol solvent mixture).

In a preferred embodiment, the at least one further polymer (C) does not have any carboxyl groups and/or carboxylate groups. In a preferred embodiment, the at least one further polymer (C) does not have any non-neutralized acid groups.

In a preferred embodiment, the at least one further polymer (C) is crystalline or amorphous. In a further preferred embodiment, the at least one further polymer (C) is crystalline or amorphous and does not have any carboxyl groups. In a further preferred embodiment, the at least one further polymer (C) is crystalline or amorphous and does not have any carboxyl groups and/or carboxylate groups.

### Component (D)

The aqueous dispersion according to the invention may optionally contain, as component (D), at least one additive other than components (A), (B) and (C).

An additive means all binders, auxiliaries and aggregates known from coatings and adhesives technology, especially emulsifiers and light stabilizers such as UV absorbers and sterically hindered amines (HALS), also antioxidants, fillers and auxiliaries, e.g. antisettling agents, defoaming and/or wetting agents, levelling aids, reactive diluents, plasticizers, neutralizing agents, catalysts, auxiliary solvents and/or thickeners and additives such as pigments, dyes or flatting agents for example. Tackifiers may also be added as additive. The additives are different from components (A), (B) and (C).

The additives can be added to the products according to the invention directly prior to processing. They may be added alone or together with components (A), (B) and (C). Components (A), (B) and (C) are preferably added as dispersions in an aqueous medium. It is alternatively possible to add at least a portion of the additives before or during the dispersing of the binder.

The selection and the metered addition of these substances, which can be added to the individual components and/or to the whole mixture, are known in principle to those skilled in the art and may be determined without unduly high effort, tailored to the specific application, by simple preliminary experiments.

The aqueous dispersions according to the invention are preferably produced by mixing the components with one another. Components (A), (B) and optionally (C) and/or (D) may be used, for example, in the form of aqueous dispersions.

The production of the aqueous dispersion according to the invention preferably comprises at least the following steps:
i) providing components (A), (B), optionally (C), optionally (D) and optionally an aqueous medium, where components (A), (B), optionally (C) and optionally (D) may each independently be in the form of an aqueous dispersion, and
ii) mixing the components provided in step i) and optionally dispersing in an aqueous medium, in order to obtain an aqueous dispersion.

The production of the aqueous dispersion according to the invention, and also the production of the individual solutions or dispersions used, can generally be effected under all conditions that seem suitable to those skilled in the art, for example at a temperature of 18 to 28° C., ideally at room temperature (23° C.), further preferably in apparatus known to those skilled in the art, for example in stainless steel, glass or enamelled process apparatus. In the course of production of the aqueous dispersion according to the invention, the formation of rust and soluble metal alloys, including from aluminium containers, must be avoided.

The aqueous dispersions according to the invention can be converted to a storage-stable and latently reactive adhesive by drying the dispersion, or by removal of the solvent. The dispersion can be dried, for example, by one or more of the following measures: infrared thermal radiation, near-infrared thermal radiation, microwaves and the use of a convection oven at elevated temperature.

The invention also relates to a method of bonding at least two substrates or at least two surface regions of a substrate, comprising at least the following steps:
(i) providing an aqueous adhesive formulation in the form of an aqueous dispersion containing at least the following dispersed components:
(A) at least one semicrystalline or crystalline polyurethane polymer containing carboxyl groups which has a melting temperature in the range of 35 to 80° C., an enthalpy of fusion of >15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C),
(ii) applying the aqueous dispersion from step (i) on at least a portion of at least one surface or a surface region of the at least one substrate, or to a suitable carrier medium for production of self-supporting adhesive films,
(iii) drying the at least one dispersion present from step (ii) in order to obtain at least one storage-stable and latently reactive adhesive layer or a storage-stable and latently reactive self-supporting adhesive film,
(iv) storing the at least one substrate or the self-supporting adhesive film from step (iii) for a period of at least 8 hours, preferably of 8 hours to 2400 hours, more preferably of 8 hours to 168 hours, at a temperature in the range from −40° C. to 30° C., and
(v) contacting the at least one storage-stable and latently reactive adhesive layer with at least one further surface region of the at least one substrate, with at least a portion of a further substrate or with at least a portion of an adhesive layer present on a further substrate, at a temperature in the range from 40° C. to 200° C., preferably from 50 to 120° C., more preferably from 55 to 100° C., or contacting the self-supporting adhesive film with at least two substrates at a temperature in the range from 40° C. to 200° C., preferably from 50 to 120° C., more preferably from 55 to 100° C.

In a preferred embodiment, the invention also relates to a method for bonding at least two substrates, comprising at least the steps of
(i) providing an aqueous adhesive formulation in the form of an aqueous dispersion containing at least the following dispersed components:
(A) at least one semicrystalline or crystalline polyurethane polymer containing carboxyl groups which has a melting temperature in the range of 35 to 80° C., an enthalpy of fusion of >15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C),
(ii) applying the aqueous dispersion from step (i) on at least a portion of at least one surface or a surface region of the at least one substrate, or to a suitable carrier medium for production of self-supporting adhesive films,
(iii) drying the at least one dispersion present from step (ii) in order to obtain at least one storage-stable and latently reactive adhesive layer or a storage-stable and latently reactive self-supporting adhesive film,
(iv) storing the at least one substrate or the self-supporting adhesive film from step (iii) for a period of at least 8 hours, preferably of 8 hours to 2400 hours, more preferably of 8 hours to 168 hours, at a temperature in the range from −40° C. to 40° C., and
(v) contacting the at least one storage-stable and latently reactive adhesive layer with at least one further surface region of the at least one substrate, with at least a portion of a further substrate or with at least a portion of an adhesive layer present on a further substrate, at a temperature in the range from 40° C. to 200° C., preferably from 50 to 120° C., more preferably from 55 to 100° C., or contacting the self-supporting adhesive film with at least two substrates at a temperature in the range from 40° C. to 200° C., preferably from 50 to 120° C., more preferably from 55 to 100° C.

The present invention also relates to a method of establishing a bond on at least one substrate, preferably at least two substrates, wherein an aqueous dispersion is applied to at least one substrate, then dried, optionally stored for a period of at least 8 hours, preferably of 8 hours to 2400 hours, more preferably of 8 hours to 168 hours, at a temperature in the range from −40° C. to 30° C., and optionally heated to a temperature in the range from 40° C. to 200° C., preferably 50° C. to 120° C., more preferably 55° C. to 100° C., followed by bonding, wherein the aqueous dispersion contains at least the following dispersed components:
(A) at least one semicrystalline or crystalline polyurethane polymer containing carboxyl groups which has a melting temperature in the range of 35 to 80° C., an enthalpy of fusion of >15 J/g, each determined by DSC (differential scanning calorimetry) at a heating rate of 20 K/min in accordance with DIN EN ISO 11357-1:2017 (2017-02), and has a partial acid number in the range from 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C).

The substrate is preferably embodied by one or more of the following: wood, plastic, metals and alloys, particleboards, MDF boards, ceramic, stone, concrete, bitumen, hard fibreboard, glass, glass fibres, carbon fibres, carbon nanotubes, porcelain, leather, textiles and/or a wide variety of different textile fibres, woven fabric, imitation leather, paper, paperboard, EVA, rubber, leather hide, ethylenevinyl acetate copolymer, polyolefin, thermoplastic polyurethane, polyurethane foam, polymer fibres and graphite fibres.

The substrates may be pretreated in order to improve adhesion of the adhesive film on the substrate. Useful pretreatments are, for example, corona, plasma, flame, chemical priming, and combinations thereof.

The aqueous dispersion according to the invention and the adhesive according to the invention are likewise suitable for bonding rubber materials, for example natural and synthetic rubbers, various plastics such as polyurethanes, polyvinylacetate, polyvinylchloride, especially plasticizer-containing polyvinylchloride. The aqueous dispersion according to the invention and the adhesives according to the invention are likewise suitable for the bonding of thermoplastics, for example ABS (acrylic-butadiene-styrene), PC (polycarbonate) and mixtures thereof, and polyolefinic plastics, optionally after suitable pretreatment.

The aqueous dispersion according to the invention is processed by the known methods of coating technology or adhesive technology with regard to the uses and processing of aqueous dispersions or aqueous emulsions or aqueous solutions.

The “applying” may mean that the aqueous dispersion or the adhesive is applied to the whole surface area of the substrate or only to one or more portions of the substrate surface.

The “applying” can be effected by painting, dipping, spraying, rolling, knife coating, flow coating, casting, printing or transfer printing, preferably by painting, dipping or spraying.

The “drying of the substrate surface or of the substrate to which the adhesive is applied” may relate solely to the heating and drying of the substrate surface or to the heating and drying of a portion of or the whole substrate including the substrate surface to which the adhesive is applied.

The “drying” can remove a volatile constituent. The volatile component may be water.

The “drying” preferably removes water.

The adhesive layers obtained after the drying preferably have a nonvolatile fraction of more than 95% by weight, more preferably more than 98% by weight, most preferably more than 99% by weight, in accordance with DIN EN ISO 3251 (2019-09), starting weight: 1 g, drying at 125° C. for 1 h.

The “drying” is preferably effected by one or more of the following measures: infrared thermal radiation, near-infrared thermal radiation, microwaves and the use of a convection oven at elevated temperature.

The heating temperature is as high as possible but should not be above the temperature limit at which the substrate is subject to uncontrolled deformation or other damage.

In the case of use of the aqueous dispersion according to the invention, for example, for bonding of substrates, and of the adhesives according to the invention, the thermal activation method is commonly employed. The adhesive layer is activated here and converted to an adhesive state by heating, for example with an infrared source. The temperature at which the adhesive film becomes tacky is referred to as the activation temperature.

The “storing” of the substrate coated with the aqueous dispersion according to the invention or of the adhesive according to the invention or of the self-supporting adhesive film is effected for a period of at least 8 hours, preferably of 8 hours to 2400 hours, more preferably of 8 hours to 168 hours, at a temperature in the range from −40° C. to 30° C.

The “contacting” is preferably effected before the temperature of the substrate surface is lower than the temperature at which the adhesive is sticky, and preferably before the temperature of the substrate surface is below 55° C.

The substrate surface treated in step iii, preferably after storage, is contacted with the substrate itself or an additional substrate in order to obtain the joined/bonded product.

The additional substrate may be any substrate that has to be bonded.

The additional substrate may be identical to or different from the substrate.

Like the substrate, the additional substrate is also preferably coated, heated and activated with heat.

After the treated substrate surface has been contacted with the substrate itself or the additional substrate in step (v), a further cooling treatment can be conducted in order to lower the temperature of the bonded product to room temperature.

The method of heat supply is preferably one or more of the following: use of a convection oven or infrared thermal radiation, near-infrared thermal radiation, microwaves, and heat transfer by an article that comes into contact with the substrate coated with the adhesive of the invention.

The present invention further provides at least two mutually bonded substrates, obtainable or obtained by the method according to the invention.

The present invention further provides a substrate where at least two surface regions thereof are bonded to one another, obtainable or obtained by the method according to the invention.

The present invention further provides an adhesive bond comprising at least two substrates and an adhesive or adhesive layer present between the at least two substrates in each case and/or a substrate and an adhesive or adhesive layer present between at least two surface regions of the substrate, obtained or obtainable by the use according to the invention or the method according to the invention.

The present invention further provides for the use of the storage-stable and latently reactive adhesives according to the invention for bonding of wood, paper, thermoplastics, elastomeric plastics, thermoplastic-elastomeric plastics, vulcanizates, textile fabrics, knits, braids, leather, metals, ceramics, asbestos cement, stoneware, concrete, foams, in each case with one another and/or on porous substrates, preferably having a density of less than 1 kg/litre, especially for the bonding of foams in the manufacture of mattresses, furniture and/or upholstery.

The aqueous dispersion according to the invention may also be applied to release paper (e.g. silicone paper or polyolefinic nonstick paper or similar carrier materials) by spray, knife, brush or roller application methods. Drying affords self-supporting, latently reactive films or nonwoven webs that, optionally after inserting a release paper, can be rolled up and stored as an adhesive film until use.

It is possible to obtain a latently reactive adhesive powder in the form of granules or a powder from the aqueous dispersion according to the invention by suitable technical methods.

For example, the aqueous dispersion according to the invention may be freed of water by spray drying. What is thus obtained is a latently reactive adhesive powder that may optionally be ground to small particle sizes by a subsequent grinding process.

Another way of producing latently reactive powders is to freeze out at least a portion of the constituents present in the aqueous dispersion according to the invention at temperatures below 0° C. This affords solids that are then largely freed of water by filtration, centrifugation etc. and finally dried.

The coarse-grain powder obtained can be brought to the required particle sizes by suitable grinding, for example in ball mills, bead mills, sand mills or jet mills.

The present invention further provides an article obtained or obtainable by the use according to the invention or the method according to the invention, wherein the article is preferably a moulded article laminated to thermoplastic film, preferably a moulded article made of plastic, wood or a wood-based material, for example MDF.

In a further preferred embodiment, the article is a footwear item or an item of furniture. In addition, it is also possible to use the aqueous dispersion according to the invention that has been developed here for the adhesive according to the invention in further applications, for example in the bonding of automobile interior parts.

The adhesives according to the invention may also be furnished with ferromagnetic particles. This allows the adhesive polymer to also be heated by induction. Heating with microwaves is also possible.

### EXAMPLES

The present invention is elucidated further by the examples that follow, without being restricted thereto.

### Raw Materials and Reagents

Polyester I: Polyester diol formed from butane-1,4-diol and adipic acid, OH value 50

Polyester II: Polyester diol formed from hexane-1,6-diol, neopentyl glycol, and adipic acid, OH value 56

Polyester III: Polyester diol formed from hexane-1,6-diol and phthalic anhydride, OH value 56

Desmodur® H: Hexamethylene 1,6-diisocyanate (Covestro Deutschland AG, Leverkusen/Germany)

Desmodur® I: Isophorone diisocyanate (Covestro Deutschland AG, Leverkusen/Germany)

Lucramul® 1820 liq: Emulsifier, 15% by weight solution of stearyl alcohol polyglycol ether in water (Levaco Chemicals GmbH, Leverkusen)

Dispercoll® U 2824 (Covestro Deutschland AG, Leverkusen, Germany) is a carboxylate-stabilized polyester polyurethane dispersion containing dimethylpropionic acid as formation component (nonvolatile fraction in the dispersion 40%). The polymer present is semicrystalline in the DSC analysis. The polyurethane dispersion has a partial acid number of 4.0 mg KOH/g. The partial acid number of the dried polymer is 10 mg KOH/g. The dried dispersion polymer has an enthalpy of fusion of 51 J/g and a melting temperature of about 47° C. The average molecular weight Mw is 65 000 g/mol.

Dispercoll® U XP 2643 (Covestro Deutschland AG, Leverkusen, Germany) is a carboxylate-stabilized polyurethane dispersion based on a polyether and dimethylpropionic acid (nonvolatile fraction of the dispersion 40%). The dried polymer does not have a melting peak in the DSC analysis; its glass transition temperature is −51° C. The product has an acid number of 4.0 mg KOH/g. The partial acid number of the dried polymer is 10 mg KOH/g. The average molecular weight Mw is 64 000 g/mol.

Desmodur® 2802 is a hydrophilically modified polycarbodiimide having a nonvolatile fraction of 40% by weight, a carbodiimide group content of about 1.4 meq DCC/g, a weight-average molecular weight Mw of 3258 g/mol and an average carbodiimide group functionality of 4.5, sourced from Covestro AG. A carbodiimide concentration of 3.5 meq DCC for the dried polycarbodiimide is calculated from the nonvolatile fraction and the carbodiimide group content. The glass transition temperature is −30° C.

NeoAdd® PAX-521 (Covestro Deutschland AG, Leverkusen, Germany) is a polymeric aziridine having a solids content of 80% in ethyl acetate.

Picassian® XL-721 is a polycarbodiimide having a nonvolatile fraction of 49% in propylene glycol diacetate (PGDA), a carbodiimide group content of about 1.15 meq DCC/g, a weight-average molecular weight Mw of 2643 g/mol from Stahl Holdings B.V. A carbodiimide concentration of 2.3 meq DCC for the dried polycarbodiimide is calculated from the nonvolatile fraction and the carbodiimide group content. The glass transition temperature is −38° C.

### Production of Polyurethane Dispersions Containing Carboxyl Groups

### Dispersion 1

450 g of polyester I and 2.3 g of dimethylolpropionic acid were dewatered at 110° C. and 15 mbar for 1 hour. 22.5 g of Desmodur® I and 34.0 g of Desmodur® H were added at 80° C., and the mixture was stirred at 90° C. until a constant isocyanate content of 1.4% had been attained. The reaction mixture was dissolved in 763 g of acetone, which cooled it to 48° C. A solution of 9.1 g of the sodium salt of N-(2-aminoethyl)-2-aminoethanesulfonic acid and 3.8 g of lysine and 2.7 g of diethanolamine in 75.0 g of water was added to the homogeneous solution with vigorous stirring. After 30 minutes, the mixture was dispersed by addition of 672 g of water. Distillative removal of the acetone afforded an aqueous polyurethane-polyurea dispersion having a solids content of 39.8% by weight. The polymer present is semicrystalline after drying with a glass transition at a glass transition temperature Tg of −53° C., a melting temperature of 48° C. and an enthalpy of fusion of 49 J/g. The partial acid number of the dispersion is 1.80 mg KOH/g.

### Dispersion 2

439.4 g of polyester I was dewatered at 110° C. and 15 mbar for 1 hour. 20.4 g of Desmodur® I and 30.9 g of Desmodur® H were added at 80° C., and stirring of the mixture was continued at 90° C. until a constant isocyanate content of 1.3% had been attained. The reaction mixture was dissolved in 677 g of acetone, which cooled it to 48° C. A solution of 8.2 g of the sodium salt of N-(2-aminoethyl)-2-aminoethanesulfonic acid, 3.4 g of lysine and 2.7 g of diethanolamine in 67.5 g of water was added to the homogeneous solution with vigorous stirring. After 30 minutes, the mixture was dispersed by addition of 652 g of water. Distillative removal of the acetone afforded an aqueous polyurethane-polyurea dispersion having a solids content of 40% by weight. The polymer present is semicrystalline after drying with a glass transition at a glass transition temperature Tg of −50° C., a melting temperature of 49° C. and an enthalpy of fusion of 47 J/g. The partial acid number of the dispersion is 0.95 mg KOH/g.

### Production of the Adhesive

The constituents of the aqueous adhesive dispersions that are specified in Table 1 are weighed successively into a plastic beaker with a screwtop lid. Mixing is effected at 1000 revolutions per minute for 3 minutes in a Speedmixer®.

What are obtained are low-viscosity aqueous adhesive formulations which, even after storage under standard conditions for several weeks, show no signs of a rise in viscosity or sedimentation.

### Test Methods

Unless stated otherwise, all analytical determinations and test methods are based on a temperature of 23° C.

### Determination of Partial Acid Number

Partial acid number is determined in accordance with DIN EN ISO 2114:2000 (2002-06, Method A), except using, rather than the solvent mixture of 2 parts by volume of toluene (5.7) and 1 part by volume of ethanol (5.5) which is specified in 5.1, a solvent mixture of 2 parts by volume of acetone (5.4) and 1 part by volume of ethanol (5.5).

The acid number of the polymer dispersions was determined by using them directly, unless stated otherwise. The amounts of sample used are guided by the specifications in 7.1.

The partial acid number of the dried polymer corresponds to the partial acid number of the solid resin as described in 8.1.2, and is calculated analogously.

### Determination of Nonvolatile Fractions

The nonvolatile fractions of the polymer dispersions were determined in accordance with DIN EN ISO 3251, starting weight: 1 g, drying at 125° C. for 1 h.

### Determination of Glass Transition Temperatures, Melting Temperatures and Enthalpies of Fusion by Differential Scanning Calorimetry (DSC)

Glass transition temperatures, melting temperatures and enthalpies of fusion were determined by differential scanning calorimetry (DSC) using a TA Instruments DSC Q2000 calorimeter.

The determination is effected in accordance with DIN EN ISO 11357-1:2017 (2017-02)—Plastics—Differential Scanning Calorimetry (DSC)—Part 1: General Principles (ISO 11357-1:2016); German version EN ISO 11357-1:2016

and the following parts of the standard:

DIN EN ISO 11357-2:2020-08—Plastics—Differential scanning calorimetry (DSC)—Part 2: Determination of glass transition temperature and step height (ISO 11357-2:2020); German version EN ISO 11357-2:2020

DIN EN ISO 11357-3:2018-07—Plastics—Differential scanning calorimetry (DSC)—Part 3: Determination of temperature and enthalpy of melting and crystallization (ISO 11357-3:2018).

### Sample Preparation for Aqueous Dispersions

For this purpose, a film was produced by knife-coating the dispersion with wet film thickness 100 μm on a glass plate, predrying at 23° C. and 50% relative humidity for 2 hours, then transferring the coated glass plate into a dry box and storing it there at 23° C. and 0% relative humidity for 3 days.

The coated glass plate is removed from the dry box, and about 5 mg of sample material is used for the DSC analysis.

The following analysis program is conducted:

Rapid cooling to the starting temperature of −100° C., followed by commencement of three heating runs from −100° C. to +150° C. at a heating rate of 20 K/min and a cooling rate of 320 K/min under a nitrogen atmosphere and with cooling with liquid nitrogen.

### Determination of Glass Transition Temperatures

Glass transition temperatures (Tg) are ascertained according to the specifications of DIN EN ISO 11357-2:2020-08.

The glass transition temperature corresponds to the temperature at half height of the glass transition, it being the third heating that was evaluated. If it should not be possible to ascertain a glass transition temperature, the analysis program is altered as follows: Rapid cooling to the starting temperature of −140° C., followed by commencement of three heating runs from −140° C. to +150° C. at a heating rate of 20 K/min and a cooling rate of 320 K/min.

### Determination of Melting Temperatures

Melting temperatures are determined from the first heating run; the melting temperatures reported correspond to the peak crystallization temperatures.

### Determination of Enthalpies of Fusion

Enthalpies of fusion are determined from the first heating run. In the case of multiple melt peaks, the enthalpies of fusion of all melt peaks having a peak melting temperature Tp,m in the range from 15 to 80° C. are added up. Peaks having enthalpies of fusion of <0.9 J/g are not considered.

### Determination of Molecular Weight

Unless stated otherwise, molecular weight Mn, Mw, Mz is determined in accordance with DIN EN ISO 13885-2:2021-11 with N,N-dimethylacetamide as eluent against a polystyrene standard.

Unless stated otherwise, molecular weight Mn, Mw, Mz of the polycarbodiimides is determined in accordance with DIN EN ISO 13885-1:2021-11 with tetrahydrofuran as eluent against a polystyrene standard.

### Calculation of the Molar Ratio of Carbodiimide Groups (—N═C═N—) in Component (B) to the Carboxyl Groups (—COOH) in Component (A)

The molar ratio of carbodiimide groups (—N═C═N—) in component (B) to the carboxyl groups (—COOH) in component (A), CDI/COOH, is calculated from the molar amount of carbodiimide groups nCDI [meq DCC] in component (B) and the molar amount of carboxyl groups nCOOH [mmol/g] in component (A).

The molar amount of COOH groups nCOOH in component (A) is calculated by the following formula:

nCOOH=partial acid number [mg KOH/g]×mass [g]/56.1[mmol/mg KOH]

If component (A) should consist of two or more polymers, it is thus possible to calculate the molar amount for each polymer and to add up the individual molar amounts.

### Determination of the Carbodiimide Concentration in Component B

Carbodiimide concentration is determined by ATR infrared spectroscopy using the Perkin Elmer Spectrum two instrument.

First of all, dicyclohexylcarbodiimide (DCC) is dissolved in ethanol (concentrations: 0.1 mmol/g, 0.2 mmol/g, 0.5 mmol/g, 1.0 mmol/g, 1.5 mmol/g, and 2 mmol/g). The IR spectra of these solutions were recorded. The peak areas (PA) of the carbodiimide band at about 2118 cm⁻¹ were determined.

The data (concentration c of the DCC solutions and the PA ascertained) are used to generate a calibration line:

PA=m·c [meq DCC/g], where m is the slope of the calibration line.

If the polycarbodiimides to be used in component B) are in the form of an aqueous dispersion, the aqueous dispersion is analysed directly in ATR infrared spectroscopy. The carbodiimide concentration is determined from PA of the band at about 2118 cm⁻¹. The carbodiimide concentration c of the aqueous dispersion [meq DCC/g] is calculated by the formula PA/m. Taking account of the nonvolatile fraction of the dispersion, this can be used to calculate the carbodiimide concentration c) of the polycarbodiimide. The carbodiimide concentration of component B) and the mass of component B), Mc, are used to determine the molar amount of carbodiimide groups nCDI [meq DCC].

nCDI [meq DCC]=Mc [g]×c [meg DCC/g] In the case of carbodiimides in solid form, the carbodiimide concentration is determined as described in WO2020216680A1 using a 25% solution in toluene and converted to solids.

The ratio of carbodiimide groups in component (B) to the carboxylic acid groups in component (A) for Example 2 in Table 1 is calculated as follows:

nCOOH=10 [mg KOH/g]×40%×100 g/56.1 [mmol/mg KOH]=7.13 mmol

nCDI [meq DCC]=14.3 [g]×40%×3.5 [meq DCC/g]=20.02 [meq DCC]

The ratio of carbodiimide groups in component (B) to the carboxylic acid groups in component (A) for Example 2 is 20.02 to 7.13, i.e. 2.8:1.

### Determination of Heat Resistance Via a Softening Point Measurement (Lap Shear Stress)

Softening point values are determined from a canvas-canvas composite combination.

The adhesive dispersions are applied with a brush to the cotton test specimens (25 mm×50 mm), so as to result in bonding areas of size 20 mm×10 mm.

The adhesive layer is dried at 23° C./50% relative humidity for 30 min. Then a second adhesive layer is applied by brush. Then the adhesive layer is dried at 23° C./50% relative humidity for a further 60 min. The adhesive-coated test specimens are heat-activated with a Funck IR source (2000 shock activation device) for 10 seconds. This increases the surface temperature of the adhesive layer to 90° C. The adhesive bond is established immediately after the thermal activation by pressing the activated adhesive layers together in a press at 4 bar for 1 min. The test specimens thus produced are stored under standard climatic conditions (23° C./50% relative humidity) for 1 week.

After the storage period, the test specimens are subjected to a load of 4 kg (lap shear stress) and heated to 40° C. in a heating cabinet within 30 min. Subsequently, the test specimens are heated up to 150° C. at a linear heating rate of 0.5 K/min. The softening point, i.e. the temperature in ° C. at which the adhesive bond fails under a load of 4 kg, is registered. 5 individual measurements were conducted in each case, and the average was determined and reported.

Determination of Heat Resistance after Storage Via a Softening Point Measurement (=Lap Shear Stress) for Determination of the Open Time of the Dried Adhesive Layer

Softening point values are determined from a canvas-canvas composite combination.

The adhesive dispersions are applied with a brush to the cotton test specimens (25 mm×50 mm), so as to result in bonding areas of size 20 mm×10 mm. The adhesive layer is dried at 23° C./50% relative humidity for 30 min. Then a second adhesive layer is applied by brush. The adhesive layer is dried at 23° C./50% relative humidity for 30 min. Then a second adhesive layer is applied by brush. Then the adhesive layer is dried at 23° C./50% relative humidity for a further 60 min.

After the adhesive layer has been dried, the coated canvas substrates, prior to thermal activation and joining, are stored under standard climatic conditions (23° C./50% relative humidity) for different periods (of hours to weeks). The open time is the maximum storage time after which, by the test method described hereinafter, a softening point of 100° C. or higher is still achieved.

The adhesive-coated test specimens are heat-activated with a Funck IR source (2000 shock activation device) for 10 seconds. This increases the surface temperature of the adhesive layer to 90° C. The adhesive bond is established immediately after the thermal activation by pressing the activated adhesive layers together in a press at 4 bar for 1 min. The test specimens thus produced are stored under standard climatic conditions (23° C./50% relative humidity) for 1 week.

After the storage period, the test specimens are subjected to a load of 4 kg and heated to 40° C. in a heating cabinet within 30 min. Subsequently, the test specimens are heated to 150° C. at a linear heating rate of 0.5 K/min. The softening point, i.e. the temperature in ° C. at which the adhesive bond fails under a load of 4 kg, is registered. 5 individual measurements were conducted in each case, and the average was determined and reported. (Figure 1)

### Test Results

TABLE 1
Test results

| | Example | | | | | | | | | |
|---|---|---|---|---|---|---|---|---|---|---|
| | 1 | 2 | 3 | 4 | 5 | 6 | 7 | 8 | 9 | 10 |
| | Example type | | | | | | | | | |
| | V | E | V | V | E | E | E | E | E | E |
| Input material | Amount used (g) | | | | | | | | | |
| Dispercoll U 2824 | 100 | 100 | — | — | — | — | — | — | 100 | 100 |
| Dispercoll U 2643 | — | — | 100 | 100 | — | — | — | — | — | — |
| Dispersion 1 | — | — | — | — | 100 | 100 | — | — | — | — |
| Dispersion 2 | — | — | — | — | — | — | 100 | 100 | — | — |
| Desmodur 2802 | — | 14.3 | — | 14.3 | 1.7 | 3.6 | 1.7 | 3.4 | — | — |
| Picassian XL-721 | — | — | — | — | — | — | — | — | 7.1 | — |
| NeoAdd PAX-521 | — | — | — | — | — | — | — | — | — | 4.8 |

Softening point after storage of the precoated substrates at 23° C./50% rh [° C.]*
(joining and thermal activation after storage of the dried adhesive for the specified period of time)

| | | | | | | | | | | |
|---|---|---|---|---|---|---|---|---|---|---|
| Immediately after drying | 49 | 150 | 51 | 146 | 150 | 150 | 150 | 150 | — | — |
| after storage for 1 hour | — | — | — | 110 | 150 | 150 | 150 | 150 | — | — |
| after storage for 3 hours | — | — | — | 97 | 150 | 150 | 150 | 150 | — | — |
| after storage for 5 hours | — | — | — | 90 | 150 | 150 | 150 | 150 | — | — |
| after storage for 24 hours | — | — | — | 62 | 150 | 150 | 150 | 150 | — | — |
| after storage for 48 hours | — | — | — | — | 150 | 150 | 150 | 150 | — | — |
| after storage for 1 week | — | 147 | — | — | 150 | 150 | 150 | 150 | 150 | 150 |
| after storage for 2 weeks | — | 147 | — | — | 150 | 148 | 150 | 150 | 150 | 150 |
| after storage for 3 weeks | — | 120 | — | — | 150 | 147 | 150 | 150 | 88 | — |
| after storage for 4 weeks | — | 93 | — | — | 150 | 143 | 150 | 150 | — | — |
| after storage for 6 weeks | — | 71 | — | — | 150 | 140 | 150 | 147 | — | — |
| after storage for 8 weeks | — | 61 | — | — | 150 | 139 | 150 | 146 | — | — |

Inventive examples are identified by E, comparative examples by V.

The results from Table 1 show that, in the case of Inventive Examples 2, 5, 6, 7, 8, 9, 10 based on a semicrystalline polyurethane dispersion containing carboxyl groups, latently reactive adhesive films are obtained, and these, even after storage for several weeks, are still capable of being processed after thermal activation to give adhesive bonds having high heat resistance (softening point).

Comparative Examples 1 and 3 demonstrate that polyurethanes containing carboxyl groups without use of polycarbodiimides do not lead to adequate heat resistances of the adhesive bonds.

It is found with reference to Comparative Example 4 that a combination of a noncrystalline polymer dispersion containing carboxyl groups with a polycarbodiimide, in the case of immediate heat activation, does lead to adhesive bonds having sufficient heat resistance, but the adhesive films do not show adequate open time on storage under standard conditions. Even after 3 h, the crosslinking of the adhesive films has advanced to such an extent that an adhesive bond with sufficient heat resistance is no longer achieved in the joining process. It is apparent that the already crosslinked polymers at the chosen activation temperature of 90° C. no longer have sufficient tack to enter into a heat-resistant adhesive bond with one another.

1. (canceled)

2. A method of bonding at least two substrates or at least two surface regions of a substrate, comprising:
(i) providing an aqueous dispersion containing at least the following dispersed components:
(A) at least one semicrystalline or crystalline polyurethane polymer containing carboxyl groups which has a melting temperature of 35 to 80° C., an enthalpy of fusion of ≥15 J/g, each determined by DSC (differential scanning calorimetry) at a heating rate of 20 K/min in accordance with DIN EN ISO 11357-1:2017 (2017-02), and has a partial acid number of 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine and/or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C),
(ii) applying the aqueous dispersion from step (i) on at least a portion of at least one surface or a surface region of the at least one substrate, or to a suitable carrier medium for production of a self-supporting adhesive film,
(iii) drying the at least one dispersion present from step (ii) to obtain at least one storage-stable and latently reactive adhesive layer or a storage-stable and latently reactive self-supporting adhesive film,
(iv) storing the at least one substrate or the self-supporting adhesive film from step (iii) for a period of at least 8 hours at a temperature in the range from −40° C. to 30° C., and
(v) contacting the at least one storage-stable and latently reactive adhesive layer with at least one further surface region of the at least one substrate, with at least a portion of a further substrate or with at least a portion of an adhesive layer present on a further substrate, at a temperature in the range from 40° C. to 200° C., or contacting the self-supporting adhesive film with at least two substrates at a temperature in the range from 40° C.

3. The method of claim 17, wherein the adhesive and/or adhesive layer is a storage-stable and latently reactive adhesive layer, a self-supporting, storage-stable and latently reactive adhesive film and/or a storage-stable and latently reactive adhesive powder.

4. The method of claim 17, wherein the adhesive and/or the adhesive layer has a storage stability of more than 14 days at a temperature of 23° C.

5. The method of claim 17, wherein the adhesive and/or the adhesive layer has an enthalpy of fusion of ≥15 J/g determined by DSC (differential scanning calorimetry) DIN EN ISO 11357-1 (2017-02).

6. The method of claim 17, wherein the at least one polyurethane polymer (A) has an average molecular weight (Mw) of 20 000 g/mol to 300 000 g/mol, determined in accordance with DIN EN ISO 13885-2 (2021-11) with N,N-dimethylacetamide as eluent and polystyrene as standard.

7. The method of claim 17, wherein the polyurethane polymer (A) has a partial acid number of 2.5 mg KOH/g to 25 mg KOH/g, determined in accordance with DIN EN ISO 2114:2000 (2002-06, Method A with an acetone-ethanol solvent mixture).

8. The method of claim 17 wherein the polyurethane polymer (A) is obtained by the reaction of the following components:
(A1) at least one diol component and/or polyol component;
(A2) at least one di- and/or polyisocyanate component;
(A3) at least one isocyanate-reactive component having at least one free carboxyl group, where the isocyanate-reactive component
(A3) is different from components (A1), (A2), (A4) and (A5);
(A4) optionally at least one component having neutralized sulfonic acid group and having isocyanate-reactive groups, where component (A4) is different from components (A1), (A2), (A3) and (A5); and
(A5) optionally at least one component selected from the group consisting of a mono-amino-functional compound, a di-amino-functional compound, a tri-amino-functional compound, and/or a mixture of at least two thereof, where component (A5) is different from components (A1), (A2), (A3) and (A4).

9. The method of claim 8, wherein
(A1) is at least one difunctional, semicrystalline or crystalline, aliphatic polyester polyol having a molecular weight (Mn) of 400 to 6000 g/mol, determined in accordance with DIN EN ISO 13885-1 (2021-11) with tetrahydrofuran as eluent and polystyrene as standard;
(A2) is at least one diisocyanate selected from the group consisting of hexamethylene diisocyanate (HDI), 1-isocyanato-3,3,5-trimethyl-5-isocyanatomethylcyclohexane (IPDI), toluene 2,4-diisocyanate (TDI), pentamethylene diisocyanate (PDI) and/or a mixture of at least two thereof;
(A3) is at least one isocyanate-reactive component selected from the group consisting of aminocarboxylic acids, hydroxycarboxylic acids and/or a mixture of at least two thereof;
(A4) is optional and is the sodium salt of N-(2-aminoethyl)-2-aminoethanesulfonic acid; and
(A5) is optional and is a component selected from the group consisting of monoethanolamine, diethanolamine, hydroxyethylethanediamine and/or a mixture of at least two thereof.

10. The method of claim 8 wherein the polyurethane polymer (A) contains:
20% by weight to 94% by weight of component A1;
5% by weight to 65% by weight, component A2;
0.25% by weight to 15% by weight, of component A3;
0% by weight to 10% by weight, of component A4; and
0% by weight to 10% by weight of component A5,
where the sum total of constituents (A1), (A2), (A3), (A4) and (A5) is 100% by weight.

11. The method of claim 17, wherein the aqueous dispersion has a partial acid number of 0.5 mg KOH/g to 10 mg KOH/g, determined in accordance with DIN EN ISO 2114:2000 (2002-06, Method A with an acetone-ethanol solvent mixture).

12. The method of claim 17, wherein component (B) is at least one polycarbodiimide and has an average molecular weight (Mw) of 500 g/mol to 100 000 g/mol determined in accordance with DIN EN ISO 13885-1 (2021-11) with tetrahydrofuran as eluent and polystyrene as standard.

13. The method of claim 12, wherein the at least one polycarbodiimide has a content of carbodiimide groups (—N═C═N—) of 0.5 mmol/g to 5 mmol/g, determined by ATR infrared spectroscopy against a dicyclocarbodiimide standard, based on the total weight of the at least one polycarbodiimide.

14. The method of claim 17, wherein the molar ratio of carbodiimide groups (—N═C═N—) to carboxyl groups (—COOH) in component (A) is 0.2:1 to 5:1.

15. The method of claim 17, wherein the aqueous dispersion contains
40% by weight to 99.5% by weight of component (A),
0.5% by weight to 40% by weight, of component (B), and
0% by weight to 50% by weight of component (C),
and the proportions of (A), (B) and (C) add up to 100% by weight.

16. An adhesive bond comprising at least two substrates and an adhesive or adhesive layer present between the at least two substrates and/or a substrate and an adhesive or adhesive layer present between at least two surface regions of the substrate, obtained by the method of claim 17.

17. A method of converting an aqueous dispersion to an adhesive and/or an adhesive layer, comprising drying or removing solvent from the aqueous dispersion, wherein the aqueous dispersion comprises:
(A) at least one semicrystalline or crystalline polyurethane polymer containing carboxyl groups which has a melting temperature of 35 to 80° C. and an enthalpy of fusion of ≥15 J/g, each determined by DSC (differential scanning calorimetry) at a heating rate of 20 K/min in accordance with DIN EN ISO 11357-1:2017 (2017-02), and which has a partial acid number of 0.8 mg KOH/g to 25 mg KOH/g, determined in accordance with DIN EN ISO 2114:2000 (2002-06, Method A with an acetone-ethanol solvent mixture);
(B) at least one polycarbodiimide, at least one polyaziridine, or a mixture thereof, where the at least one polycarbodiimide and the at least one polyaziridine have a glass transition temperature in the range from −150° C. to 30° C., determined by DSC (differential scanning calorimetry) DIN EN ISO 11357-1 (2017-02);
(C) optionally at least one further polymer other than the at least one polymer (A); and
(D) optionally at least one additive other than components (A), (B) and (C).

18. The method of claim 2, wherein the at least one polyurethane polymer (A) has an average molecular weight (Mw) of 20 000 g/mol to 300 000 g/mol, determined in accordance with DIN EN ISO 13885-2 (2021-11) with N,N-dimethylacetamide as eluent and polystyrene as standard.

19. The method of claim 2, wherein the polyurethane polymer (A) has a partial acid number of 2.5 mg KOH/g to 25 mg KOH/g, determined in accordance with DIN EN ISO 2114:2000 (2002-06, Method A with an acetone-ethanol solvent mixture).

20. The method of claim 2, wherein the polyurethane polymer (A) is obtained by the reaction of the following components:
(A1) at least one diol component and/or polyol component;
(A2) at least one di- and/or polyisocyanate component;
(A3) at least one isocyanate-reactive component having at least one free carboxyl group, where the isocyanate-reactive component (A3) is different from components (A1), (A2), (A4) and (A5);
(A4) optionally at least one component having neutralized sulfonic acid group and having isocyanate-reactive groups, where component (A4) is different from components (A1), (A2), (A3) and (A5); and
(A5) optionally at least one component selected from the group consisting of a mono-amino-functional compound, a di-amino-functional compound, a tri-amino-functional compound, and/or a mixture of at least two thereof, where component (A5) is different from components (A1), (A2), (A3) and (A4).
